(19) United States
(12) Patent Application Publication
(10) Pub. No.: US 2021/0170767 A1
(43) Pub. Date: Jun. 10, 2021

(54) PRINTING DEVICE

(71) Applicant: BROTHER KOGYO KABUSHIKI KAISHA, Nagoya-shi (JP)

(72) Inventors: Yutaka KAKIGAHARA, Nagoya-shi (JP); Kenta HAYASHIDA, Inazawa-shi (JP); Yoshikazu SHIMIZU, Kasugai-shi (JP)

(73) Assignee: BROTHER KOGYO KABUSHIKI KAISHA, Nagoya-shi (JP)

(21) Appl. No.: 17/181,019

(22) Filed: Feb. 22, 2021

Related U.S. Application Data
(63) Continuation of application No. PCT/JP2019/032660, filed on Aug. 21, 2019.

(30) Foreign Application Priority Data
Aug. 24, 2018 (JP) 2018-157812

(51) Int. Cl. B41J 11/00; B41J 11/66; B41J 13/00; B41J 2/175; B41J 2/18; B41J 2/145

(52) U.S. Cl. CPC B41J 11/00214; B41J 11/00216; B41J 11/66; B41J 2/145; B41J 2/17596; B41J 2/18; B41J 13/0009

(57) ABSTRACT

There is provided a printing apparatus including: a casing; a conveyance route formed in an internal space of the casing; a printing head positioned in the internal space of the casing, and configured to eject an ink to the sheet passing through the conveyance route; and a fixing device positioned in the internal space of the casing, at a location, of the conveyance route, at a downstream in the conveyance direction of the printing head, and configured to apply, to the sheet having the ink adhered thereon, an energy for fixing the ink so as to fix the ink to the sheet. A shortest distance A between the fixing device and the discharge port is longer than a shortest distance B between the printing head and the fixing device.

### CROSS REFERENCE TO RELATED APPLICATION

The present application is a continuation of International Application No. PCT/JP2019/032660 filed on Aug. 21, 2019 which claims priority from Japanese Patent Application No. 2018-157812 filed on Aug. 24, 2018. The entire contents of the referenced applications are incorporated by reference.

### TECHNICAL FIELD

The present invention relates to a printing apparatus which applies, to a sheet having an ink ejected from a printing head adhered thereon, an energy for fixing the ink to the sheet so as to fix the ink to the sheet, and which discharges the sheet from a discharge port of a casing.

### BACKGROUND ART

There is known a printing apparatus provided with a fixing device capable of applying, to a sheet having an ink ejected from a nozzle of a printing head adhered thereon, an energy for fixing the ink to the sheet. As an example of the fixing device, there is known a heater which heats a sheet having an ink adhered thereon, and there is known a printing apparatus which executes printing by heating, with the heater, a sheet having an ink ejected from a printing head adhered thereon. There is a long sheet which is continuous in a conveyance direction as an example of a print medium. The long sheet after the printing performed thereon is discharged from a discharge port of a casing to the outside of the casing.

### SUMMARY

Regarding the printing apparatus having the fixing device such as a heater, etc., installed in the inside of the casing, a part or component arranged in the vicinity of the discharge port of the casing receives the heat generated in the fixing device such as the heater, etc., and thus is adversely affected in a variety of manner, in some cases. In particular, in a case that the casing is miniaturized to be placeable on a tabletop (desktop), the internal space of the casing becomes small, which in turn causes the heat radiation of the fixing device such as the heater, etc., easily affects the above-described part or component.

The present disclosure has been made in view of the above-described situation, and an object of the present disclosure is to provide a means for causing any adverse effect of the heat radiated by the fixing device, such as the heater, etc., positioned in the internal space of the casing of the printing apparatus, to be less likely to occur.

According to an aspect of the present disclosure, there is provided a printing apparatus including a casing; a conveyance route formed in an internal space of the casing, wherein a sheet passes through the conveyance route in a conveyance direction toward a discharge port opened in an outer wall of the casing; a printing head positioned in the casing, and configured to eject an ink to the sheet passing through the conveyance route; and a fixing device positioned in the casing, at a location, of the conveyance route, at a downstream in the conveyance direction of the printing head, and configured to apply, to the sheet having the ink adhered thereon, an energy for fixing the ink so as to fix the ink to the sheet. A shortest distance A between the fixing device and the discharge port is longer than a shortest distance B between the printing head and the fixing device.

According to the above-described configuration, it is possible to reduce the size along the conveyance direction of the casing, while arranging the printing head and the heater such that any effect of the heat radiation from the heater is not generated.

### BRIEF DESCRIPTION OF THE DRAWINGS

FIG. 1 is a perspective view of a printing apparatus 10, on a side of a front surface 14A.

FIG. 2 is a schematic view depicting the internal structure of the printing apparatus 10.

FIG. 3 is a schematic view depicting the internal structure of the printing apparatus 10, as seen from thereabove.

FIG. 4 is a schematic view depicting the internal structure of a printing head 24.

FIG. 5 is a view corresponding to FIG. 2, and depicting a case that a heater 26 is arranged to be shifted upward in an up-down direction.

FIG. 6 is a schematic view depicting the internal structure of a printing apparatus 10 according to a modification having a cooling mechanism 48.

FIG. 7 is a schematic view depicting the internal structure of a printing apparatus 10 according to a modification.

FIG. 8 is a schematic view depicting the internal structure of a printing apparatus 310.

FIG. 9 is a schematic view depicting the internal structure of the printing apparatus 310, as seen from thereabove.

### DESCRIPTION OF THE EMBODIMENTS

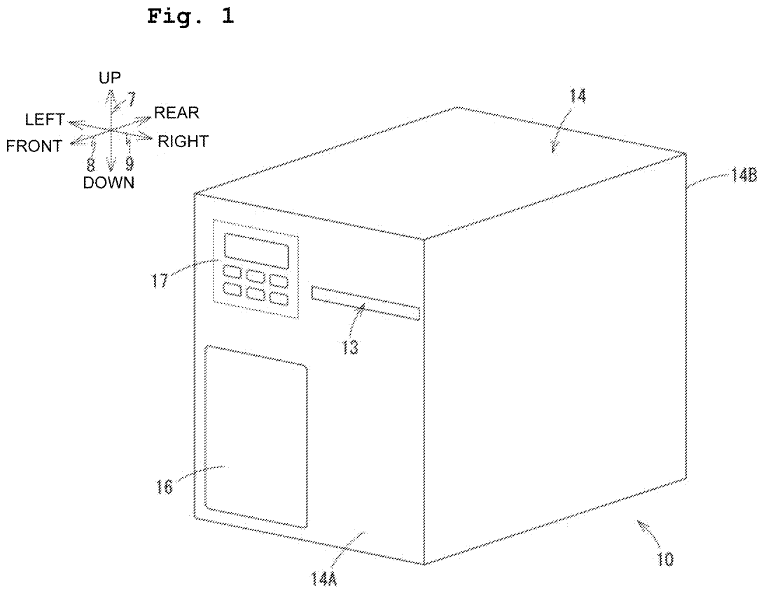

A printing apparatus 10 according to an embodiment of the present disclosure will be explained below. Note that an embodiment which is to be explained below is merely an example of the present disclosure; it is needless to say that the embodiment can be appropriately changed within a range not changing the gist of the present disclosure. Further, in the following explanation, an up-down direction 7 is defined, with a state in which the printing apparatus 10 is usably or operably installed (the state of FIG. 1) as the reference; a front-rear direction 8 is defined, with a side on which a discharge port 13 is provided is defined as a front side (front surface); and a left-right direction 9 is defined, with the printing apparatus 10 as seen from the front side (front surface).

<Overall Configuration of Printing Apparatus 10>

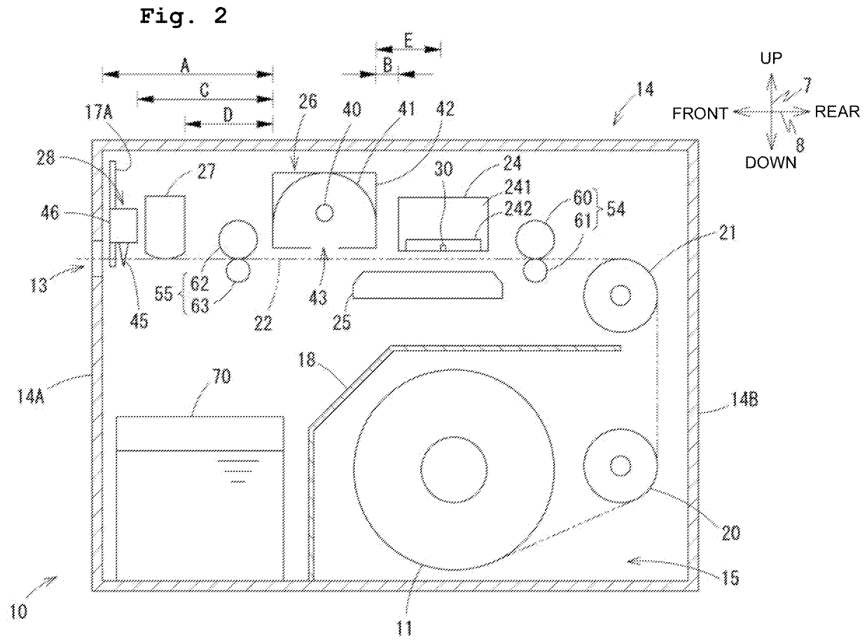

As depicted in FIG. 1, the printing apparatus 10 records an image on roll paper 11 (see FIG. 2: an example of a “sheet”), etc., in the ink-jet recording system. A casing 14 has a substantially rectangular parallelepiped shape in which the discharge port 13 is formed in a front surface 14A (an example of a “surface of an outer wall”) of the casing 14. The discharge port 13 is positioned in the front surface 14A on the right side in the left-right direction 9. The casing 14 has a size placeable on the tabletop (desktop). Namely, the printing apparatus 10 is suitable for being used while being placed on the tabletop. Of course, the printing apparatus 10 may be used while being placed on a floor surface.

An operation panel 17 is positioned, in the front surface 14A of the casing 14, on the left side in the left-right direction 9 with respect to the discharge port 13. The operation panel 17 has, for example, a display, an input key, etc. A user performs, in the operation panel 17, an input for operating the printing apparatus 10 and/or an input for confirming a variety of settings.

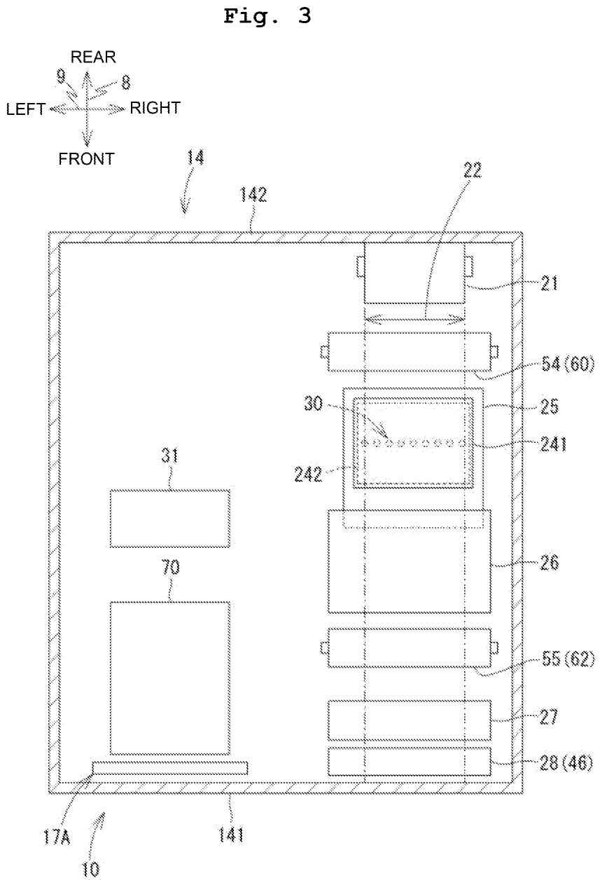

As depicted in FIGS. 2 and 3, a circuit board 17A in which an electronic part, etc., for controlling the display and the input key of the operation panel 17 is positioned at a location on the rear side of the operation panel 17 in the front-rear direction 8. The circuit board 17A is positioned at a location, on the left side in the left-right direction 7, inside the casing 17. The circuit board 17A has a main surface orthogonal to the front-rear direction 8. An input-output interface circuit with respect to the display and the input key is installed in the main surface of the circuit board 17A. The circuit board 17A is arranged at a position which is between an opening of the discharge port 13 and a CIS 27 in the front-rear direction 8.

A cover 16 is provided at a location below the operation panel 17. The cover 16 is opened to thereby expose an internal space of the casing 14. A tank 70 (to be described later on) is positioned at the rear side of the cover 16. The cover 16 in a closed state is a part of the front surface 14A of the casing 14.

<Internal Structure of Printing Apparatus 10>

As depicted in FIG. 2, a sheet storing space 15 capable of storing the roll sheet 11 therein is formed in the internal space of the casing 14, at the rear side in the front-rear direction 8. The sheet storing space 15 is a space defined in the internal space of the casing 14 by a partition wall 18. In the sheet storing space 15, the roll paper 11 is stored, with the left-right direction 9 as a roll axis direction (roll shaft direction). The sheet storing space 15 is opened to orient upward, at the rear side in the front-rear direction 9. Namely, a gap, through which a sheet pulled or drawn from the roll sheet 11 is passable, is defined between the partition wall 18 and a rear wall 14B of the casing 14.

Feeding rollers 20 and 21 are positioned in the sheet storing space 15 and at a location immediately above the sheet storing space 15, respectively. The sheet drawn rearward from the roll paper 11 is wound on the feeding roller 20 and extends upward, and further is wound on the feeding roller 21 and extends frontward. An uppermost position in the circumferential surface of the feeding roller 21 is similar, in the up-down direction 7, to the discharge port 13.

A conveyance route 22 is formed to span between the feeding roller 21 and the discharge port 13. The conveyance route 22 extends substantially linearly. Although not depicted in detail in the respective drawings, the conveyance route 22 is a space which is defined by guide members positioned away from each other in the up-down direction 7, a printing head 24, a platen 25, a heater 26, etc., and through which the sheet is passable. In the conveyance route 22, the front side is the downstream side in the conveyance direction.

As depicted in FIGS. 2 and 3, a conveyance roller pair 54 is provided on the conveyance route 22 at the upstream in the conveyance direction of the printing head 24. The conveyance roller pair 54 has a conveyance roller 60 and a pinch roller 61. A conveyance roller pair 55 is provided on the conveyance route 22 at the downstream in the conveyance direction of the heater 26. The conveyance roller pair 55 has a conveyance roller 62 and a pinch roller 63. The conveyance roller 60 and the conveyance roller 62 are rotated by rotation of a motor (not depicted in the drawings) transmitted thereto. The conveyance roller 60 and the conveyance roller 62 rotate in a state that a sheet extending from the roll paper 11 is pinched or held between the respective rollers constructing the conveyance roller pairs 54 and 55, and the conveyance roller pair 54 and the conveyance roller pair 55 thereby convey the sheet.

In the front-rear direction 8, the printing head 24, the platen 25 and the heater 26 are positioned between the conveyance roller pair 54 and the conveyance roller pair 55. Further, any other conveyance roller is not positioned in a part, of the conveyance route 22, between the conveyance roller pair 54 and the conveyance roller pair 55.

As depicted in FIGS. 2 and 3, the printing head 24 is located above the conveyance route 22 and faces the platen 25, at the downstream of the conveyance roller pair 54. The printing head 24 is positioned above the sheet storing space 15. The printing head 24 has a part overlapping with the sheet storing space 15 in the up-down direction 7.

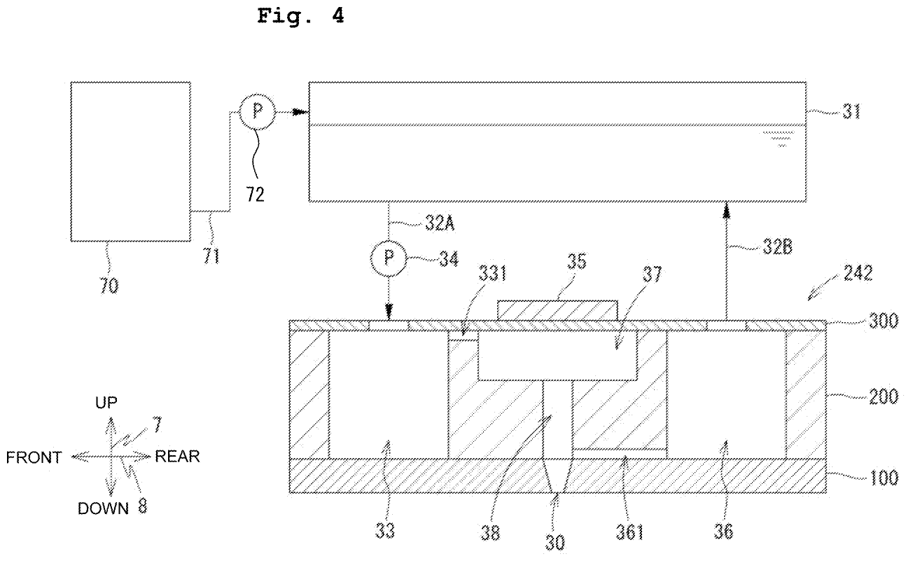

The printing head 24 of the present embodiment includes an ejecting module 242 provided with a plurality of nozzles 30, and a carriage 241 to which the ejecting module 240 is attached. The carriage 241 is attached to a rail (not depicted in the drawings) extending along the left-right direction 9 so that the carriage 241 is slidably movable thereon. As depicted in FIG. 4, the plurality of nozzles 30 are formed while being aligned in the left-right direction 9 in a lower surface of the printing head 24, namely a lower surface of the printing head 24. The printing apparatus 10 of the present embodiment is an ink-jet printer of the line system which ejects an ink to a sheet which is being conveyed, in a state that the printing head 24 stands still at a printing position which is a position at which the printing head 24 faces the sheet passing on the platen 25 during a printing operation. The plurality of nozzles 30 of the ejecting module 242 are aligned over the entire length of the sheet which is being conveyed. In a case that the printing apparatus 10 is in a standby state, or that the printing apparatus 10 is switched OFF, the printing head 24 stands by at a standby position located on the left side with respect to the conveyance route 22.

As depicted in FIGS. 2 and 3, the tank 70 is positioned in the internal space of the casing 14, at a location on the rear side of the cover 16. The tank 70 stores the ink. As depicted in FIG. 4, the ink is supplied to the printing head 24 from the tank 70 via a tube 71. The tank 70 is of a cartridge type which is attachable/detachable with respect to the casing 14; in a case that the cover 16 is opened, the tank 70 is removable toward the front side from the casing 14.

The ink is a liquid including a pigment, minute particles of a resin, etc., and is a so-called latex ink. The ink has a viscosity which is suitable for dispersing the pigment and/or the minute particles of the resin uniformly in the ink. The pigment serves as a color of the ink. The minute particles of the resin is for fixing the pigment to the sheet, and are, for example, minute particles of a synthetic resin which exceed the glass-transition temperature by being heated by the heater 26. The latex ink includes another publicly known component(s), as the composition thereof.

As depicted in FIG. 4, the printing head 24 is connected to a sub tank 31 by two channels 32A and 32B. Each of the channels 32A and 32B is formed, for example, of a tube made of a synthetic resin. The channel 32A via which the ink is supplied from the sub tank 31 to the printing head 24 is provided with a pump 34. The pump 34 is driven to circulate the ink between the printing head 24 and the sub tank 31 while the printing head 24 is ejecting the ink. The sub tank 31 is connected to the tank 70 by the tube 71. A pump 72 is provided on the tube 71. In a case that a remaining amount of the ink inside the sub tank 31 becomes small, the pump 72 is driven to thereby supply the ink from the tank 70 to the sub tank 31. The sub tank 31 is arranged on the left side with respect to the conveyance route 22.

As depicted in FIG. 4, the ejecting module 242 has the plurality of nozzles 30, a supplying manifold 33, a plurality of supplying channels 331, a plurality of piezoelectric elements 35, a discharging manifold 36, a plurality of discharging channels 361, a plurality of pressure chambers 37 and a plurality of descenders 38. The plurality of nozzles 30, the plurality of descenders 38, the plurality of pressure chambers 37, the plurality of supplying channels 331 and the plurality of discharging channels 361 are a plurality of individual channels provided corresponding to the plurality of nozzles 30, respectively.

Note that FIG. 4 depicts a cross section, of the ejecting module 241, which is orthogonal to the left-right direction 9. On the other hand, the plurality of individual channels are arranged side by side in the left-right direction 9. Accordingly, FIG. 4 depicts a nozzle 30, a descender 38, a pressure chamber 37, a supplying channel 331 and a discharging channel 361 constructing a certain individual channel among the plurality of individual channels. Further, the plurality of piezoelectric elements 35 are arranged side by side in the left-right direction 9 in a number which is same as the number of the plurality of nozzles 30. The supplying manifold 36 is a common channel which is provided commonly to the plurality of individual channels.

The supplying manifold 33 is a space communicating with the channel 32A. The supplying manifold 33 is communicated with the plurality of pressure chambers 37 via the plurality of supplying channels 331, respectively. The supplying manifold 33 supplies the ink to each of the plurality of nozzles 30 via one of the plurality of pressure chambers 37. The discharging manifold 36 is a space communicating with the channel 32B. The discharging manifold 36 is communicated with the plurality of descenders 38 via the plurality of discharging channels 361, respectively. The ink which is not ejected from the plurality of nozzles 30 flows into the discharging manifold 36.

The plurality of pressure chambers 37 are spaces provided on the plurality of nozzles 30, respectively. The plurality of descenders 38 are formed from the plurality of pressure chambers 37 toward the plurality of nozzles 30, respectively. The ink in each of the plurality of nozzles 37 is allowed to pass through one of the plurality of descenders 38 and to flow into one of the plurality of nozzles 30.

The ejecting modules 242 has a structure in which a nozzle plate 100, a channel member 200, a vibration plate 300, and the plurality of piezoelectric elements 35 are overlaid in the up-down direction 7. The plurality of nozzles 30 are formed in the nozzle plate 100. The supplying manifold 33, the plurality of supplying channels 331, the discharging manifold 36, the plurality of discharging channels 361, the plurality of pressure chambers 37, and the plurality of descenders 38 are formed in the channel member 200. Note that the channel member 200 may be a stacked body in which a plurality of plates are stacked on each other in the up-down direction 7. The vibration plate 300 is stacked on the channel member 200, and the vibration plate 300 covers the supply manifold 33, the plurality of pressure chambers 37 and the discharging manifold 366. The plurality of piezoelectric elements 35 are arranged side by side on the vibration plate 200.

The plurality of piezoelectric elements 35 are positioned on the plurality of pressure chambers 37, respectively. Each of the plurality of piezoelectric elements 35 is deformed by being applied with a voltage so as to reduce the volume of one of the plurality of pressure chambers 37. In a case that the volume of a pressure chamber 37, among the plurality of pressure chambers 37, is reduced accompanying with the deformation of a certain piezoelectric elements 35 among the plurality of piezoelectric elements 35, the ink stored in the pressure chamber 37 flows into a nozzle 30, among the plurality of nozzles 30 via a descender 38, among the plurality of descenders 38, and is ejected from the nozzle 30 to the outside as a fine or minute ink droplet. The ink droplets of the ink are selectively ejected from the plurality of nozzles 30 to thereby cause the ink to be adhered, in a shape of an image and/or letter, to the sheet passing below the printing head 24.

The pump 34 is driven while the ink is being ejected from the nozzle(s) 30, namely, while the printing is being performed, thereby circulating the ink from the sub tank 31, via the two channels 32A and 21B, and through the supplying manifold 33, the plurality of pressure chambers 37, the plurality of descenders 38 and the discharging manifold 36.

As depicted in FIG. 2, the platen 25 is located at a location below the printing head 24. An upper surface of the platen 25 is a surface supporting the sheet. Although not depicted in the respective drawings, an opening in which suction pressure is generated is formed in the upper surface of the platen 25. By the suction pressure generated on the upper surface of the platen 25, the sheet makes tight contact with the upper surface of the platen 25.

As depicted in FIGS. 2 and 3, the heater 26 is positioned at a location which is above the conveyance route 22 and which is at the downstream of the printing head 24 and at the upstream of the conveyance roller pair 55. Namely, in the front-rear direction 8, the heater 26 is positioned between the conveyance roller pair 55 and the head 24. The heater 26 has a part which overlaps with the platen 25 in the up-down direction 7. In the present embodiment, a downstream end in the conveyance direction of the platen 25 is positioned at the downstream of an upstream end in the conveyance direction of the heater 26.

The heater 26 is a so-called halogen heater and has a halogen lamp 40 as a heating element, a reflective plate 41, and a casing 42. The casing 42 has a substantially rectangular parallelepiped shape. An opening 43 along the left-right direction 9 is formed at a lower wall of the casing 42. The heat from the halogen lamp 40 and/or the reflective plate 41 is radiated to the outside, via the opening 43. The halogen lamp 40 is positioned in an internal space of the casing 42. The halogen lamp 40 has a slender cylindrical shape of which longitudinal direction is the left-right direction 9. In the internal space of the casing 42, the reflective plate 41 is positioned at a location above the halogen lamp 40. The reflective plate 41 is a metallic plate on which a ceramic film, etc., is coated or applied, and is curved to have a circular-arc shape of which center axis is in the vicinity of the opening 43. Note that it is allowable to use, instead of using the reflective plate 41, a halogen lamp 40 on which a ceramic film, etc., is coated. The heater 26 heats the ink adhered to the sheet passing a location below the opening 43. The ink is heated to thereby allow the minute particles of the resin to undergo the glass transition, which in turn melts the minute particles of the resin. After the sheet has passed the location below the heater 26, the sheet is cooled to thereby cure the molten resin, and to fix the ink to the sheet.

As depicted in FIGS. 2 and 3, a CIS 27 (contact image sensor: an example of a “reading sensor”) is positioned at a location above the conveyance route 22, and at the downstream in the conveyance direction of the heater 26. In a case that a reflected light, of a light emitted from a light source such as an LED and reflected by the sheet, is collected to a line sensor by a SELFOC (trade name) lens, the CIS 27 is configured to output an electric signal corresponding to the intensity of the reflected light received by the line sensor. The CIS 27 is arranged so that the left-right direction 9 is a read-line. The CIS 27 is provided so as to detect whether or not there is any defect in an image formed on the sheet by the printing head 24.

As depicted in FIGS. 2 and 3, a cutter unit 28 is positioned in the conveyance route 22 at the downstream in the conveyance direction of the CIS 27. The cutter unit 28 is constructed such that a cutter 45 is installed in a carriage 46. The carriage 46 moves in the conveyance route 22 in the left-right direction 9, by a non-illustrated belt driving mechanism, etc. The cutter unit 45 is positioned to as to cross the conveyance route 22 in the up-down direction 7, and moves in the conveyance route 22 in the left-right direction 9, accompanying with the movement of the carriage 46. The sheet positioned in the conveyance route 22 is cut along the left-right direction 9 (an example of a “direction crossing the conveyance direction”) by the movement of the cutter 45.

<Arrangement of Respective Members in Internal Space of Casing 14>

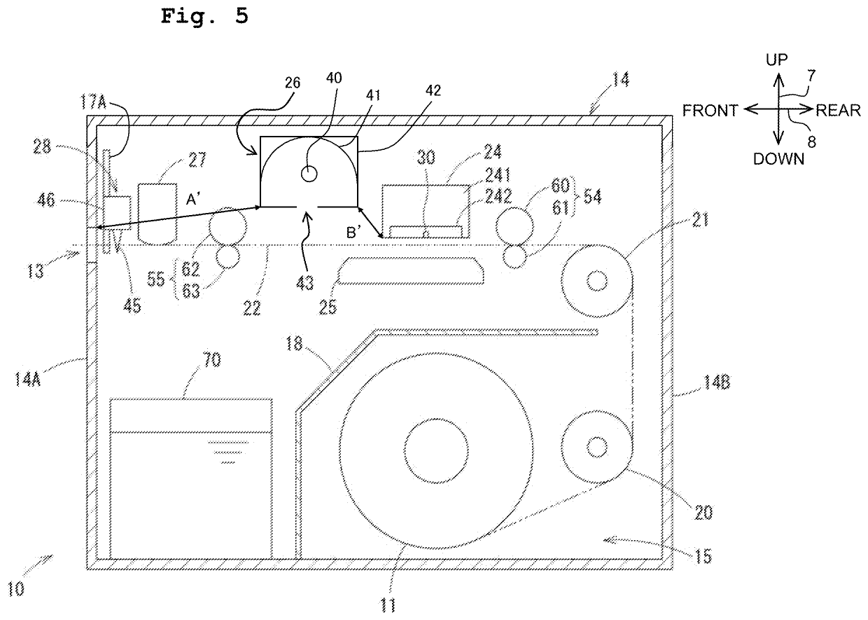

As depicted in FIG. 2, a shortest distance A between the heater 26 and the discharge port 13 is longer than a shortest distance B between the printing head 24 and the heater 26 (A>B). Here, the term “shortest distance” is the shortest distance among distances connecting the end parts of the respective elements, respectively, such as the heater 26, the printing head 24, etc. In the present embodiment, a distance in the front-rear direction 8 from an end part on the front side of the casing 42 to an end part on the rear side of the discharge port 13 is the shortest distance A. Further, in the present embodiment, a distance in the front-rear direction 8 from an end part on the front side of the printing head 24 to an end part on the rear side of the casing 42 is the shortest distance B. Noter that it is not necessarily indispensable that the shortest distance is the distance along the front-rear direction 8. For example, as depicted in FIG. 5, in a case that the heater 26 is arranged to be shifted to the upper side in the up-down direction 8, a distance from a lower corner part on the front side of the casing 42 to an end part on the rear side of the discharge port 13 becomes a shorted distance A′. Further, a distance from an end part on the front side of the printing head 24 to a lower corner part on the rear side of the casing 42 becomes to be the shortest distance B′.

Further, as depicted in FIG. 2, in the present embodiment, a shortest distance C between the heater 26 and the cutter unit 28 is longer than the shortest distance B (C>B). Furthermore, a shortest distance D between the heater 26 and the CIS 27 is longer than the shortest distance B (D>B). Namely, the CIS 27 and the cutter unit 28 are positioned at positions, respectively, which are farther from the printing head 24, with respect to the heater 26. In the present embodiment, a distance in the front-rear direction 8 from the end part on the front side of the casing 42 to an end part on the rear side of the cutter unit 28 is the shortest distance C. Further, in the present embodiment, a distance in the front-rear direction 8 from the end part on the front side of the casing 42 to an end part on the rear side of the CIS 27 is the shortest distance D. Furthermore, in the present embodiment, the shortest distance D between the heater 26 and the CIS 27 is longer than a shortest distance E between the heater 26 and the plurality of nozzles 30 (D>E).

<Effects of Embodiment>

In a case that the printing apparatus 10 performs the printing operation, the halogen lamp 40 radiates the heat, and the heat radiation is generated in the surrounding of the heater 26. According to the configuration of the printing apparatus 10, however, it is possible to make the size along the front-rear direction 8 of the casing 14 to be small, while arranging, with respect to the heater 26, the printing head 24, the CIS 27, the cutter unit 28 and the discharge port 13 so that there is no effect of the heat radiation from the heater 26.

Further, in the conveyance route 22, the printing head 24 and the heater 26 are positioned between the conveyance roller pair 54 and the conveyance roller pair 55 and any other conveyance roller is not positioned between the conveyance roller pair 54 and the conveyance roller pair 55. Therefore, it is possible to reduce the size along the front-rear direction 8 of the casing 14 to be small.

Furthermore, since the heater 26 has the part overlapping with the platen 26 in the up-down direction 7 in the conveyance route 22, it is possible to reduce the size along the front-rear direction 8 of the casing 14 to be small.

Moreover, since the discharge port 13 and the operation panel 17 are positioned in the front surface 14A of the casing 14, it is possible for the user to receive the sheet after the printing and discharged from the discharge port 13, and to operate the operation panel 17, on the side of the front surface 14A of the casing 14. Thus, there is provided a satisfactory operability.

Further, since the printing head 24 has the part overlapping with the sheet storing space 15 in the up-down direction 7, it is possible to reduce the size along the up-down direction 7 and the front-rear direction 8 of the casing 14 to be small.

Furthermore, the printing head 24 has the structure in which the ink is circulated. The sub tank 31 is arranged at the position further away from the heater 26 than the printing head 24. Namely, the distance from the sub tank 31 to the heater 26 is greater than the distance from the printing head 24 to the heater 26. Accordingly, the sub tank 31 is less likely to be affected by the heat radiation of the heater 26, than the printing head 24, and the sub tank 31 is a more cooled state than the printing head 24. Accordingly, it is possible to adjust the temperature of the printing head 24 to be not more than a predetermined temperature, by the circulation of the ink. With this, the printing head 24 is less likely to adversely affected by the head radiation of the heater 26. For example, it is possible to prevent such a situation that any distortion is generated in the printing head 24 due the heat received by the printing head 24 from the heater 26, and that the ejection of the ink is adversely affected. Further, it is possible to prevent such a situation that adhesion between the constituent elements constructing the printing head 24 is disintegrated (peeled off from each other) due to, for example, any distortion generated in the printing head 24, and that the printing head 24 is destroyed.

Furthermore, the ejecting module 242 has the configuration in which the ink in the vicinity of the nozzles 30 is circulated during the printing operation. Accordingly, any drying of the ink and/or any increase in the viscosity of the ink due to the heat received from the heater 26 are/is less likely to be generated.

<Modifications>

In the above-described explanation, each of the shortest distance A, the shortest distance B, the shortest distance C and the shortest distance D is explained as being defined as the shortest distance among the distances between the respective ends of the respective constituent elements such as the heater 26 and the printing head 24, etc., for the purpose of explaining the arrangement relationship among the respective constituent elements. It is allowable, however, to define each of the shortest distance A, the shortest distance B, the shortest distance C and the shortest distance D as the shortest distance among the distances between the respective ends of the respective constituent elements such as the halogen lamp 40 and the printing head 24, etc., instead of the heater 26.

Namely, a shortest distance A between an end part on the front side of the halogen lamp 40 and the end part on the rear side of the discharge port 13 is longer than a shortest distance B between the end part on the front side of the printing head 24 and an end part on the rear side of the halogen lamp 40 (A>B). Further, a shortest distance C between the end part on the front side of the halogen lamp 40 and the end part on the rear side of the cutter unit 28 is longer than the shortest distance B (C>B). Furthermore, a shortest distance D between the end part on the front side of the halogen lamp 40 and the end part on the rear side of the CIS 27 is longer than the shortest distance B (D>B). Namely, the CIS 27 and the cutter unit 28 are positioned at positions, respectively, which are farther from the printing head 24, with respect to the halogen lamp 40.

Moreover, it is allowable to define the arrangement of the respective members in the internal space of the casing 14 by a distance A, a distance B, a distance C and a distance D each of which is a direction along the conveyance direction (in the above-described embodiment, the front-rear direction 8), instead of the shortest distance A, the shortest distance B, the shortest distance C and the shortest distance D as described above. In this case, it is not necessary that each of the distance A, the distance B, the distance C and the distance D is the shortest distance. In the resent embodiment, the conveyance direction is a direction along a horizontal direction. Accordingly, it is allowable to define the arrangements of the respective members in the internal space of the casing 14 based on the distance A, the distance B, the distance C and the distance D each of which is the distance along the horizontal direction, instead of the shortest distance A, the shortest distance B, the shortest distance C and the shortest distance D as described above.

Namely, a distance A along the front-rear direction 8 between the end part on the front side of the heater 26 (namely, the end part on the front side of the casing 42) and the end part on the rear side of the discharge port 13 is longer than a distance B along the front-rear direction 8 between the end part on the front side of the printing head 24 and the end part on the rear side of the heater 26 (namely, the end part on the rear side of the casing 42) (A>B). Further, a distance C along the front-rear direction 8 between the end part on the front side of the heater 26 and the end part on the rear side of the cutter unit 28 is longer than the distance B (C>B). Furthermore, a distance D along the front-rear direction 8 between the end part on the front side of the heater 26 and the end part on the rear side of the CIS 27 is longer than the distance B (D>B).

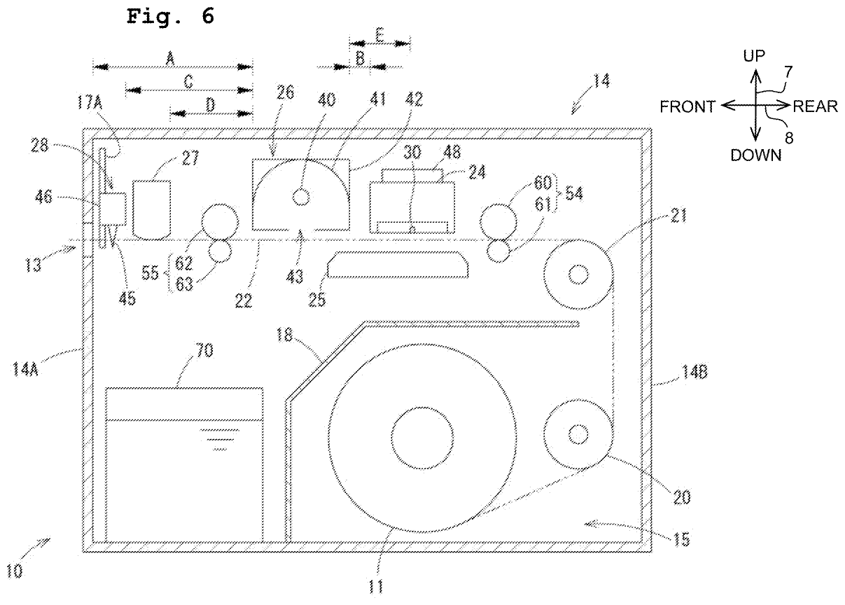

Moreover, as a modification of the above-described embodiment, it is allowable to provide a cooling mechanism 48 on the printing head 24, as depicted in FIG. 6. In a case that the cooling mechanism 48 is a cooling mechanism by (based on) the air cooling, a heat sink made of a metal is provided on the printing head 24. Alternatively, in a case that the cooling mechanism 48 is a cooling mechanism by the water cooling, a water cooling block which is connected to a pump and in which a refrigerant medium is allowed to circulate may be provided on the printing head 24. It is allowable that the cooling mechanism 48 is configured to cool a non-illustrated driving IC configured to drive the piezoelectric elements 35, or is provided to adjust the temperature of the ink inside the printing head 24.

Further, in the embodiment as described above, the heater 26 has the halogen lamp 40 as the heating element. The present disclosure, however, is not limited to this. For example, it is allowable to use a carbon heater, a ceramic heater, etc., instead of using the heater 26.

In the above-described embodiment, the printing apparatus 10 is provided with the heater 26. The heater 26 heats the sheet to which the ink has been ejected so as to fix the ink to the sheet. As described above, the ink is heated directly or indirectly by the heater 26, to thereby subject the minute particles of the resin included in the ink to the glass transition. Then, the sheet is cooled to thereby cure the resin which has undergone the glass transition. In such a manner, the heater 26 applies the energy for subjecting the minute particles of the resin included in the ink to the glass transition to thereby cure the ink and to fix the ink to the sheet. In other words, the heater 26 functions as a fixing device which applies the energy necessary for curing ink so as to fix the ink to the sheet. Note that in the above-described disclosure, the ink is explained as being exemplified by a latex ink. The present disclosure, however, is not limited to or restricted by a thermo-curable ink such as the latex ink. For example, it is allowable to use a water-based ink such as a dye ink, a pigment ink, etc., as the ink. In such a case also, the heater 26 functions as a fixing device which applies the energy required for drying the ink adhered to the sheet so as to fix the ink to the sheet.

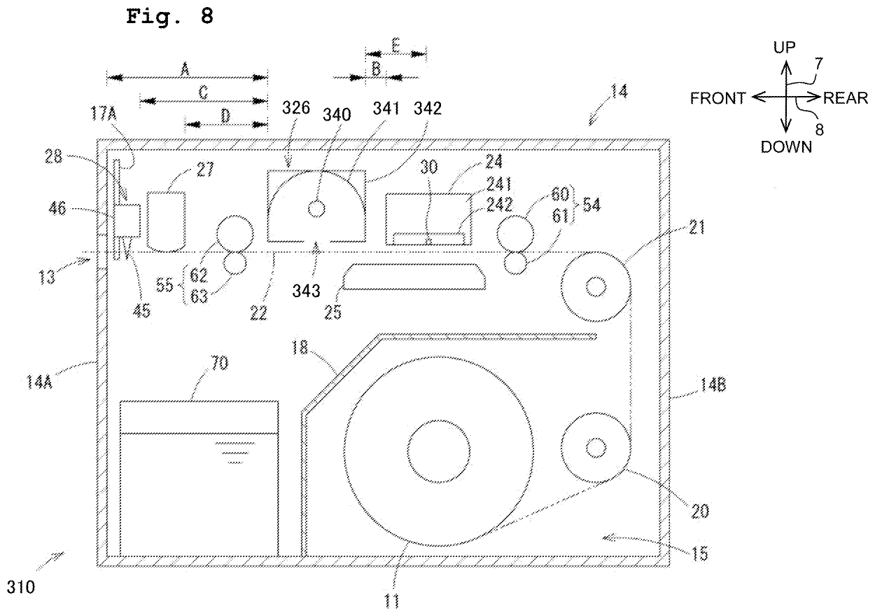

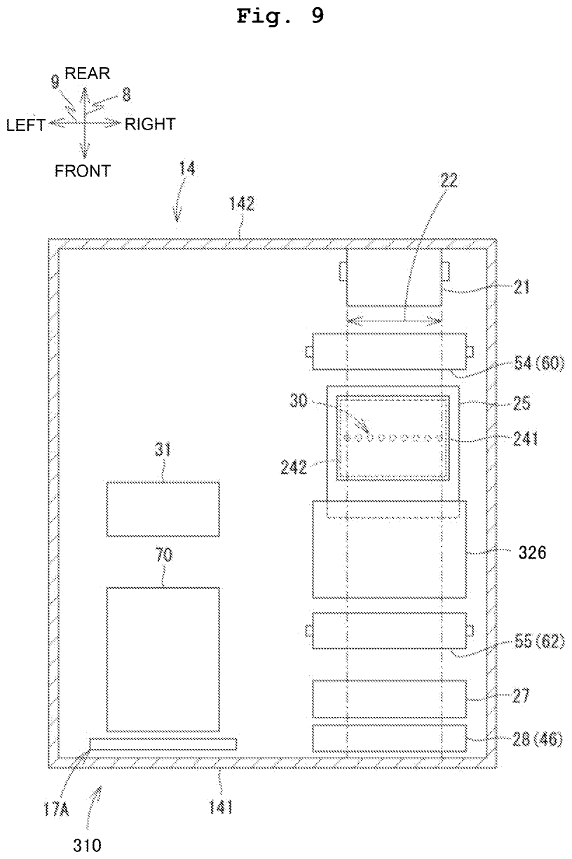

In the present disclosure, the fixing device which applies the energy required for curing the ink so as to fix the ink to the sheet is not limited to the heater which applies a thermal energy to the ink. For example, as a printing apparatus 310 as depicted in FIGS. 8 and 9, it is allowable to use a UV light source 326 as the fixing device. The printing apparatus 310 as depicted in FIG. 8 has a similar configuration as that of the printing apparatus 10 of the above-described embodiment, except that the printing apparatus 310 does not have the heater 26, but instead has a UV light source 326. Same reference numerals are affixed to configurations, of the printing apparatus 310, which are similar to those of the printing apparatus 10, and the explanation therefor will be omitted.

The UV light source 326 has a UV lamp 340 which radiates a UV light, a reflective plate 341 and a casing 342. Since the outer shape of the casing 342 is substantially same as the outer shape of the casing 42 of the heater 26, any explanation therefor will be omitted. An opening 343 along the left-right direction 9 is formed in a lower wall of the casing 342. The UV light from the UV lamp 340 and/or the reflective plate 341 is radiated to the outside, via the opening 343. In the internal space of the casing 342, the reflective plate 341 is positioned at a location above the UV lamp 340. The reflective plate 341 is formed of, for example, a surface-treated aluminum member in which an anodic oxide film is formed on a surface thereof, and is capable reflecting the UV light. Further, the reflective plate 341 is curved to have a circular-arc shape of which center axis is in the vicinity of the opening 343. Note that it is allowable to arrange a condensing lens between the UV lamp 340 and the sheet passing at a location below the opening 343. In such a case, it is possible to efficiently collect the UV light radiated from the UV lamp 240 and to irradiate the sheet with the UV light.

In this modification, a UV curable ink is used as the ink. Further, the UV light source 326 radiates the UV light to the UV curable ink adhered to the sheet passing the location below the opening 343. By radiating the UV light to the UV curable ink, the UV curable ink is cured. With this, the UV curable ink is fixed to the sheet.

Further, in the above-described embodiment, the tank 70 is of the cartridge type which is attachable/detachable with respect to the casing 14; in a case that the cover 16 is opened, the tank 70 is removable toward the front side from the casing 14. Instead of this, it is allowable that the tank 70 is fixed in the internal space of the casing 14, and that the ink can be replenished in the storing space of the tank 70 via an inlet port.

Furthermore, the tank 70 is not limited to a tank storing the ink of one color which is black, and may be tanks which store, for example, four color inks which are black, yellow, cyan and magenta, respectively.

Moreover, it is not necessarily indispensable that the discharge port 13 is formed in the front surface 14A of the casing 14. For example, it is allowable that the discharge port 13 is provided on the upper surface of the casing 14, and that a part of the roll paper 11 after the printing which pass through the discharge port 13 is discharged obliquely upward or upward.

Further, although the printing apparatus 10 as described above is capable of performing printing on the roll paper 11, the present disclosure is not limited to this. It is allowable that the printing apparatus 10 is an apparatus which performs printing on the roll paper 11 and a cut paper sheet (cut paper), or may be an apparatus which performs printing only on the cut paper sheet.

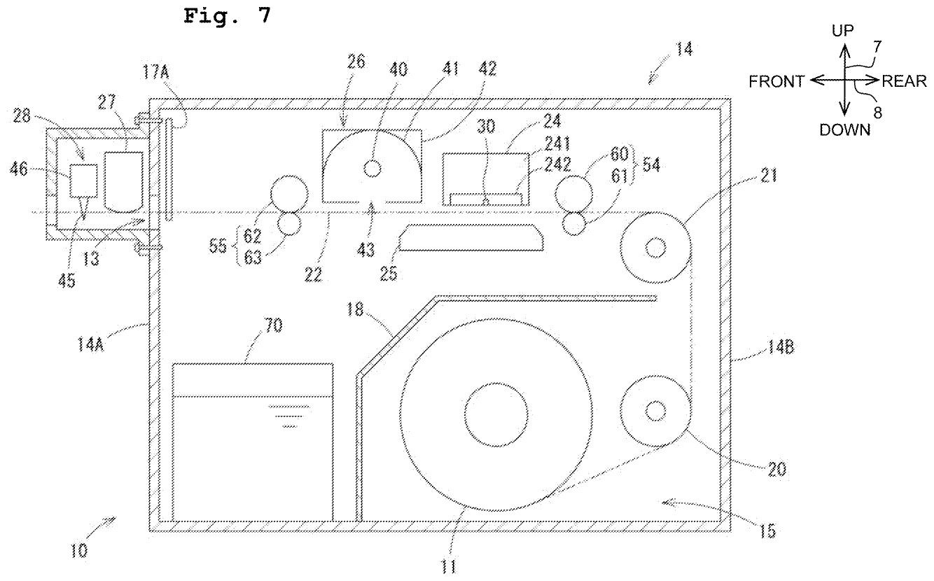

Furthermore, in the above-described embodiment, the CIS 27 and the cutter unit 28 are positioned in the inside of the casing 14. Instead of this, it is allowable that the CIS 27 and the cutter unit 28 are positioned, at the outside of the casing 14, at the downstream in the conveyance direction of the discharge port 13, as depicted in FIG. 7. Moreover, it is allowable that the CIS 28 is omitted.

Further, although the above-described printing apparatus 10 is used in a state that the front surface 14A and the rear surface 14B of the casing 14 are along the up-down direction 7 and the left-right direction 9, a posture in which the printing apparatus 10 is used is not limited to this.

Further, although the ejecting module 242 of the above-described embodiment is explained while being exemplified by having one nozzle array (row) in which the plurality of nozzles 30 are aligned in the left-right direction 9, the present embodiment is not limited to this. It is allowable that an ejecting module in which a plurality of nozzle rows are arranged side by side in the front-rear direction 9 is used for the printing apparatus 10.

Furthermore, although the printing head 24 as described above is explained as having one ejecting module 242, the present embodiment is not limited to this. The printing apparatus 10 may be a printing apparatus 10 provided with, as the printing head 24, a line head in which a plurality of ejecting modules 242 are installed in one carriage 241.

Moreover, in the above-described embodiment, although the printing head 24 ejects the ink in the state that the printing head 24 stands still at the predetermined printing position during the printing operation, the printing apparatus 10 may be a printing apparatus 10 of the serial system in which the printing head 24 ejects the ink while the printing head 24 moves in the left-right direction 9 during the printing operation.

Further, in the above-described embodiment, although the printing head 24 is explained as being provided with the ejecting module 242 of such a type wherein the pump 34 is driven to thereby circulate the ink in the vicinity of the nozzles 30 during the printing operation, it is allowable to use an ejecting module in which an ink circulating route is formed only for the manifold, without circulating the ink in the individual channels, as disclosed in Japanese Patent Application Laid-open No. 2016-190431.

Further, the above-described embodiment is explained as making the ink inside the ejecting module 242 to circulated by the pump 34 during the printing operation. It is allowable, however, that the ink inside the ejecting module 242 is not circulated during the printing operation. Also in this case, a new ink is always supplied from the tank 70 or the sub tank 31, due to the ejection of the ink by the printing operation. Since the ink in a cooled state than the printing head 24 is supplied from the tank 70 and/or the sub tank 31, it is possible to cool the printing head 24.

Furthermore, in the above-described embodiment, although the route for circulating the ink is formed in the ejecting module 242, it is allowable to use an ejecting module which does not have any route for circulating the ink.

The present disclosure can be applied to the following aspects. In the printing apparatus the fixing device may be a heater having a heating element, or may be a UV light source. Further, the printing apparatus may further include a cutter which is positioned in the casing, at a location, of the conveyance route, at the downstream in the conveyance direction of the heater, and which cuts the sheet in a direction crossing the conveyance direction, wherein a shortest distance C between the heater and the cutter may be longer than the shortest distance B.

According to the above-described configuration, it is possible to reduce the size along the conveyance direction of the casing, while arranging the cutter and the heater such that any effect of the heat radiation from the heater is not generated.

The printing apparatus may further include a cutter which is positioned at the downstream in the conveyance direction of the discharge port, and which cuts the sheet in a direction crossing the conveyance direction.

The printing apparatus may further include a reading sensor which is positioned in the casing, at a location, of the conveyance route, at the downstream in the conveyance direction of the heater, and which reads an image of a print surface of the sheet, wherein a shortest distance D between the fixing device and the reading sensor may be longer than the shortest distance B.

According to the above-described configuration, it is possible to reduce the size along the conveyance direction of the casing while arranging the reading sensor and the heater such that any effect due to the heat radiation of the fixing device such as the heater, etc., is not generated.

The printing apparatus may further include a reading sensor which is positioned at the downstream in the conveyance direction of the discharge port, and which reads an image of a print surface of the sheet.

The printing apparatus may further include: a first conveyance roller which is positioned in the casing at an upstream in the conveyance direction of the printing head, and which conveys the sheet in the conveyance direction; and a second conveyance roller which is positioned in the casing at the downstream in the conveyance direction of the heater, and which conveys the sheet in the conveyance direction. It is allowable that the printing head and the heater are positioned between the first conveyance roller and the second conveyance roller in the conveyance direction, and it is further allowable that another conveyance roller is not positioned between the first conveyance roller and the second conveyance roller in the conveyance direction.

According to the above-described configuration, it is possible to reduce the size along the conveyance direction of the casing while arranging the printing head and the heater in the range between the first conveyance roller and the second conveyance roller.

The printing apparatus may further include a platen which is positioned to face the printing head in the casing, and which supports the sheet. The platen may have a part overlapping with the fixing device in a direction orthogonal to the conveyance direction and orthogonal to a supporting surface of the platen.

According to the above-described configuration, it is possible to reduce the size along the conveyance direction of the casing while arranging the printing head, the platen and the fixing device in the range between the first conveyance roller and the second conveyance roller.

The printing apparatus may further include an operation panel which is positioned in a surface, of the outer wall of the casing, having the discharge port formed therein, and via which an input from a user is received.

According to the above-described configuration, it is possible to receive the sheet, after printing and discharged from the discharge port, on the surface, of the outer wall of the casing, in which the discharge port is formed and to operate the operation panel on the same surface. Thus, a satisfactory operability is provided.

The printing apparatus may further include a sheet storing space storing the sheet which is a roll-shaped sheet before printing, with a direction crossing the conveyance direction being a roll axis direction of the roll-shaped sheet. The printing head may have a part overlapping with the sheet storing space in a direction orthogonal to the conveyance direction and orthogonal to the roll axis direction.

According to the above-described configuration, a small-sized casing is realized by arranging the sheet storing space and the printing head efficiently in the casing.

The printing apparatus may further include: a tank configured to store the ink; a channel member defining a channel communicating the printing head and the tank with each other; and a pump which circulates the ink, via the channel, between the printing head and the tank.

According to the above-described configuration, since the printing head is cooled by the ink circulated in the printing head, the printing head is less likely to be affected by the heat radiation of the fixing device such as the heater, etc.

The printing head may have: a plurality of nozzles via which the ink to be ejected flows, and a manifold communicating with the plurality of nozzles; the channel may be communicated with the manifold; and the pump may be operated so as to circulate the ink between the manifold and the tank, via the channel.

The printing head may have a cooling mechanism by air coiling or water cooling.

The ink may be a liquid including minute particles of a resin, or may be a UV-curable ink.

The heating element may radiate an infrared ray.

According to a second aspect of the present disclosure, there is provided a printing apparatus including: a casing; a conveyance route which is formed in an internal space of the casing and through which a sheet passes in a conveyance direction toward a discharge port opened in an outer wall of the casing; a printing head which is positioned in the casing and which ejects an ink to the sheet passing through the conveyance route; and a heater which has a heating element, which is positioned in the casing, at a location, of the conveyance route, at a downstream in the conveyance direction of the printing head, and which heats the sheet having the ink adhered thereon. A shortest distance A between the heating element and the discharge port is longer than a shortest distance B between the printing head and the heating element.

The printing apparatus may further include cutter which is positioned in the casing, at a location, of the conveyance route, at the downstream in the conveyance direction of the heater, and which cuts the sheet in a direction crossing the conveyance direction. A shortest distance C between the heating element and the cutter may be longer than the shortest distance B.

The printing apparatus may further include a reading sensor which is positioned in the casing, at a location, of the conveyance route, at the downstream in the conveyance direction of the heater, and which reads an image of a print surface of the sheet. A shortest distance D between the heating element and the reading sensor may be longer than the shortest distance B.

According to a third aspect of the present disclosure, there is provided a printing apparatus including: a casing; a conveyance route which is formed in an internal space of the casing and through which a sheet passes in a conveyance direction toward a discharge port opened in an outer wall of the casing; a printing head which is positioned in the casing and which ejects an ink to the sheet passing through the conveyance route; and a fixing device which is positioned in the casing, at a location, of the conveyance route, at a downstream in the conveyance direction of the printing head, and which is configured to apply, to the sheet having the ink adhered thereon, an energy for fixing the ink so as to fix the ink to the sheet. A distance A along the conveyance direction between the fixing device and the discharge port is longer than a distance B along the conveyance direction between the printing head and the fixing device.

The printing apparatus may further include a cutter which is positioned in the casing, at a location, of the conveyance route, at the downstream in the conveyance direction of the heater, and which cuts the sheet in a direction crossing the conveyance direction. A distance C along the conveyance direction between the fixing device and the cutter may be longer than the distance B.

The printing apparatus may further include a reading sensor which is positioned in the casing, at a location, of the conveyance route, at the downstream in the conveyance direction of the fixing device, and which reads an image of a print surface of the sheet. A distance D along the conveyance direction between the fixing device and the reading sensor may be longer than the distance B.

According to the present disclosure, any adverse effect of the heat radiated by the fixing device, such as the heater, etc., positioned in the casing of the printing apparatus, is less likely to occur.

What is claimed is:

1. A printing apparatus comprising:
a casing in which a conveyance route is formed, wherein a sheet passes through the conveyance route in a conveyance direction toward a discharge port opened in an outer wall of the casing;
a printing head positioned in the casing, and configured to eject an ink toward the sheet passing through the conveyance route; and
a fixing device positioned in the casing, at a location, of the conveyance route, at a downstream in the conveyance direction of the printing head, and configured to apply, to the sheet having the ink adhered thereon, an energy for fixing the ink so as to fix the ink to the sheet,
wherein a shortest distance A between the fixing device and the discharge port is longer than a shortest distance B between the printing head and the fixing device.

2. The printing apparatus according to claim 1, wherein the fixing device is a heater including a heating element.

3. The printing apparatus according to claim 1, wherein the fixing device is a UV light source.

4. The printing apparatus according to claim 1, further comprising a cutter positioned in the casing, at a location, of the conveyance route, at the downstream in the conveyance direction of the fixing device, and configured to cut the sheet in a direction crossing the conveyance direction,
wherein a shortest distance C between the fixing device and the cutter is longer than the shortest distance B.

5. The printing apparatus according to claim 1, further comprising a cutter positioned at the downstream in the conveyance direction of the discharge port, and configured to cut the sheet in a direction crossing the conveyance direction.

6. The printing apparatus according to claim 1, further comprising a reading sensor positioned in the casing, at a location, of the conveyance route, at the downstream in the conveyance direction of the fixing device, and configured to read an image of a print surface of the sheet,
wherein a shortest distance D between the fixing device and the reading sensor is longer than the shortest distance B.

7. The printing apparatus according to claim 1, further comprising a reading sensor positioned at the downstream in the conveyance direction of the discharge port, and configured to read an image of a print surface of the sheet.

8. The printing apparatus according to claim 1, further comprising:
a first conveyance roller positioned in the casing at an upstream in the conveyance direction of the printing head, and configured to convey the sheet in the conveyance direction; and
a second conveyance roller positioned in the casing at the downstream in the conveyance direction of the heater, and configured to convey the sheet in the conveyance direction,
wherein the printing head and the heater are positioned between the first conveyance roller and the second conveyance roller in the conveyance direction, and another conveyance roller is not positioned between the first conveyance roller and the second conveyance roller in the conveyance direction.

9. The printing apparatus according to claim 1, further comprising a platen positioned to face the printing head in the casing, and configured to support the sheet,
wherein the platen including a part overlapping with the fixing device in a direction orthogonal to the conveyance direction and orthogonal to a supporting surface of the platen.

10. The printing apparatus according to claim 1, further comprising an operation panel configured to receive an input from a user, and positioned in a surface, of the outer wall of the casing, including the discharge port formed therein.

11. The printing apparatus according to claim 1, further comprising a sheet-storing space storing the sheet which is a roll-shaped sheet before printing, with a direction crossing the conveyance direction being a roll axis direction of the roll-shaped sheet,
wherein the printing head includes a part overlapping with the sheet storing space in a direction orthogonal to the conveyance direction and orthogonal to the roll axis direction.

12. The printing apparatus according to claim 1, further comprising:
a tank configured to store the ink;
a channel member defining a channel communicating the printing head and the tank with each other; and
a pump configured to circulate the ink, via the channel, between the printing head and the tank.

13. The printing apparatus according to claim 12, wherein the printing head includes:
a plurality of nozzles, and
a manifold communicating with the plurality of nozzles;
wherein the channel is communicated with the manifold; and
wherein the pump is configured to circulate the ink between the manifold and the tank, via the channel.

14. The printing apparatus according to claim 12, wherein the printing head includes a cooling mechanism by air cooling or water cooling.

15. The printing apparatus according to claim 2, wherein the ink is a liquid including minute particles of a resin.

16. The printing apparatus according to claim 3, wherein the ink is a UV-curable ink.

17. The printing apparatus according to claim 2, wherein the heating element is configured to radiate an infrared ray.

18. A printing apparatus comprising:
a casing in which a conveyance route is formed, wherein a sheet passes through the conveyance route in a conveyance direction toward a discharge port opened in an outer wall of the casing;
a printing head positioned in the casing, and configured to eject an ink to the sheet passing through the conveyance route; and
a heater including a heating element, positioned in the casing, at a location, of the conveyance route, at a downstream in the conveyance direction of the printing head, and configured to heat the sheet having the ink adhered on the sheet,
wherein a shortest distance A between the heating element and the discharge port is longer than a shortest distance B between the printing head and the heating element.

19. The printing apparatus according to claim 18, further comprising a cutter positioned in the casing, at a location, of the conveyance route, at the downstream in the conveyance direction of the heater, and configured to cut the sheet in a direction crossing the conveyance direction,
wherein a shortest distance C between the heating element and the cutter is longer than the shortest distance B.

20. The printing apparatus according to claim 18, further comprising a reading sensor positioned in the casing, at a location, of the conveyance route, at the downstream in the conveyance direction of the heater, and configured to read an image of a print surface of the sheet,
wherein a shortest distance D between the heating element and the reading sensor is longer than the shortest distance B.

21. A printing apparatus comprising:
a casing in which a conveyance route is formed, wherein a sheet passes through the conveyance route in a conveyance direction toward a discharge port opened in an outer wall of the casing;
a printing head positioned in the casing and configured to eject an ink to the sheet passing through the conveyance route; and
a fixing device positioned in the casing, at a location, of the conveyance route, at a downstream in the conveyance direction of the printing head, and configured to apply, to the sheet having the ink adhered thereon, an energy for fixing the ink so as to fix the ink to the sheet,
wherein a distance A along the conveyance direction between the fixing device and the discharge port is longer than a distance B along the conveyance direction between the printing head and the fixing device.

22. The printing apparatus according to claim 21, wherein the fixing device is a heater including a heating element.

23. The printing apparatus according to claim 21, wherein the fixing device is a UV light source.

24. The printing apparatus according to claim 21, further comprising a cutter positioned in the casing, at a location, of the conveyance route, at the downstream in the conveyance direction of the fixing device, and configured to cut the sheet in a direction crossing the conveyance direction,
wherein a distance C along the conveyance direction between the fixing device and the cutter is longer than the distance B.

25. The printing apparatus according to claim 21, further comprising a reading sensor positioned in the casing, at a location, of the conveyance route, at the downstream in the conveyance direction of the fixing device, and configured to read an image of a print surface of the sheet,
wherein a distance D along the conveyance direction between the fixing device and the reading sensor is longer than the distance B.
